(19) United States
(12) Patent Application Publication
(10) Pub. No.: US 2003/0101052 A1
(43) Pub. Date: May 29, 2003

(54) Voice recognition and activation system

(76) Inventors: Lang S. Chen, Fremont, CA (US); Michael K. Yeung, Fremont, CA (US); Zhenyu L. Liu, Pleasanton, CA (US)

Correspondence Address: PATENT LAW OFFICES OF DAVID MILLERS, 6560 ASHFIELD COURT, SAN JOSE, CA, 95120, US

(21) Appl. No.: 09/972,308

(22) Filed: Oct. 5, 2001

(51) Int. Cl. G10L 19/12

(52) U.S. Cl. 704/223

(57) ABSTRACT

Voice processing methods and circuits use bandpass filters and energy detectors to determine the energy in frequency channels of a voice signal. A bit array having a horizontal direction corresponding to the channels and a vertical direction corresponding to time provides a representation of the voice signal that can be stored during training and compared to other bit arrays during voice recognition. One comparison method compares horizontal lines of bit arrays using a position-weighted K factor. A segmentation process divides arrays into segments to better identify corresponding lines in arrays. Corresponding lines can also be selected in segments using an alternating top-down/bottom-up best match process. When this comparison finds a matching array, the match is confirmed if match result is significantly better than a match result for a bit array corresponding to different voice command and if vertical checking confirms the match. Thresholds indicating horizontal and vertical matching arrays and the required gap between the match results of different commands can be set according to the desired voice recognition sensitivity.

### BACKGROUND

Most electronic devices require switches or buttons such as found on a computer keyboard, a mouse, a telephone keypad, or the press pad of a microwave oven as the input elements for activation and control of the devices. However, voice recognition is a rapidly developing technology that provides the convenience of using voice commands as input to the electronic devices. Voice recognition technology can permit hands-free operation of devices to improve user convenience and the safety of devices such as cellular telephones and car stereo systems that are used during operation of an automobile or other equipment. Voice activation also allows a user to remotely control operation of devices such as computers, telephones televisions, video systems, or audio systems without special equipment such as a remote control or a computer interface.

Voice recognition systems and processes to date have generally required significant amounts of processing power to analyze voice signals and recognize words or commands. In particular, voice recognition software can tax the capabilities of currently available personal computers, and most other consumer electronic devices such as televisions, video systems, audio systems, and telephones do not have the necessary processing power for today's voice recognition systems. Accordingly, in view of the need and desire for voice-activated operation of a variety of electronic devices, voice activation systems that do not require expensive processors or other expensive hardware are sought.

### SUMMARY

In accordance with an aspect of the invention, voice processing methods and circuits use filters such as bandpass filters and energy detectors to determine the energy in frequency channels of a voice signal. A bit array having a horizontal direction corresponding to the channels and a vertical direction corresponding to time can be generated according to the energies in the channels to provide a simple representation of the voice signal. The bit array can be stored during training and compared to other bit arrays during voice recognition.

One comparison method compares horizontal lines of bit arrays using a position-weighted K factor. A segmentation process divides arrays into segments to better identify corresponding lines in arrays being compared. Lines can also be selected and compared within bit arrays or segments using an alternating top-down/bottom-up process.

During voice recognition, when comparisons of horizontal lines indicates a stored bit array matches a voice bit array, the match is only confirmed if a match result (e.g., a match percentage) is significantly better than match results for any other stored bit arrays and if results of vertical ORing of lines in corresponding segments match. Accordingly, a match is found if the best-match stored bit array when compared to the voice bit array provides a match result that is above a first threshold and separated from the second best match result by more than a required gap and provides a vertical match result above a second threshold. The thresholds required for match results found in horizontal and vertical comparisons of bit arrays and the required gap between the match results of different commands can be set according to the desired voice recognition sensitivity.

Our specific embodiment of the invention is a voice circuit that includes filters such as bandpass filters connected in parallel to receive a voice signal. An energy detection circuit connected to outputs of the filters determines amounts of energy in respective output signals from the filters. The energy detection circuit can be either an analog circuit or a digital circuit that determines peak amplitudes of the output signals of the filters during a series of intervals.

The voice circuit can further include a processing circuit such as a microcontroller or microprocessor connected to the energy detection circuit. The processing circuit generates a bit array representing time evolution of the energy in the output signals of the filters. In one embodiment, the bit array includes a set of lines. Each line corresponds to a time interval and contains bits in correspondence with the plurality of filters. In particular, each bit has a value “0” or “1” indicating whether the output signal of the corresponding filter was above a threshold during the time interval corresponding to the line containing the bit. The threshold can be an average of the energies of the output signals of the filters during the time interval corresponding to the line.

Another embodiment of the invention is a voice processing method that constructs bit arrays representing voice signals. During training, the voice signals are assigned functions and are stored in a non-volatile memory containing a library of bit arrays. During voice recognition, the bit array constructed from a voice signal is compared to bit arrays from the library in an attempt to find a match. If a match is found, the function corresponding to the matching stored array is activated.

In an exemplary embodiment, the voice bit array includes multiple lines of bits, and each bit in a line has a value indicating whether in the voice signal, a frequency band corresponding to the bit had an energy greater than a threshold level during a time interval corresponding to the line. Lines of bit arrays can be compared to each other to determine whether the lines match. In accordance with an aspect of the invention, a position-weighted K factor determination can provide a quantitative indication of how well two lines match. One such method for comparing first and second lines determines a K factor by combining contributions associated with the bits of the first line. Each bit in the first line has a contribution that is: zero if the bit is equal to an identically-positioned bit in the second line; a first value if the bit is not equal to the identically-positioned bit in the second line and is equal to either bit adjacent to the identically-positioned bit in the second line; and a second value if the bit is not equal to an identically-positioned bit in the second line and not equal to any bit adjacent to the identically-positioned bit in the second line. Generally, the second value is greater than (e.g., twice) the first value.

One technique used in comparing bit arrays splits the bit arrays into matching segments. The matching segments can be separately compared to each other. One specific segmentation method includes selecting a voice bit array or a stored bit array as a source array and selecting the other of the voice bit array and the stored bit array as a target array. Generally, the smaller bit array is the source array, and the larger bit array is the target array. After selecting the source array, the segmentation method compares a middle line of the source array to each line in a range of lines containing a middle line of the target array and from the comparisons identifies in the range, a best match line for the middle line. The middle line of the source array and the best match line in the target array provide dividing lines for splitting each of the voice bit array and the stored array into two segments. The segmenting process can be repeated on selected segments to divide the bit arrays into more segments.

Comparisons of bit arrays or sections of bit arrays can employ an alternating top-down/bottom-up selection of lines for matching. One such method includes identifying a portion of the voice bit array and a portion of a stored bit array to be compared to each other. The portions can be segments or bit arrays from which already compared lines have been removed. One of the identified portions (typically the smaller portion) becomes a source array, and the other portion (typically the larger portion) becomes a target array. The comparison the continues by comparing an end line (e.g., top or bottom line) of the source array to a series of lines in the target array to identify a best matching line in the series. The series begins at an end line (e.g., top or bottom line) in the target array and proceeds in a selected direction (e.g., down or up). After finding a best match line in the series, the comparison reselects source and target arrays, switches to the other ends of the source and target arrays, and switches the selected direction. The process repeats to alternate between the top and bottom lines of the bit arrays or sections.

Another method for comparing the voice bit array to the stored bit array includes: partitioning each of the voice bit array and the stored bit array into a plurality of segments. Each segment contains multiple lines, and each segment of the voice bit array has a corresponding segment in the stored bit array. For each segment, OR operations on all bits of the vertical lines of the segment generates an OR result line for the segment. The OR result lines of matching segments in the voice bit array and the stored array can be compared, for example, using the position-weighted K factor method, to determine whether the segments match. A match percentage can be determined from the match results of all the segments.

Another method in accordance with the invention compares the voice bit array to all stored bit arrays in a library to determine whether any of the stored bit arrays match the voice bit array. One embodiment of this method includes comparing lines in the voice bit array to lines in each of the stored bit arrays to generate for each stored bit array a match value indicating how well the voice bit array matches the stored bit array. A first match value for the best-matching stored array is then compared to a first threshold, and if this best match value is less than the first threshold, the process ends with no match being found. Otherwise the process continues and identifies a second stored bit array having a second match value indicating out of the stored bit arrays, the second stored bit array matches the voice bit array second best. The process ends with no match being found if a difference between the first match value and the second match value is less than a required gap. Otherwise, the process performs a vertical comparison of the best-match stored bit array and the voice bit array, and compares that result to a second threshold. The process ends with no match being found if the vertical comparison provides a match result less than the second threshold. A system can select the first and second thresholds and the gap according to the desired voice recognition sensitivity.

### BRIEF DESCRIPTION OF THE DRAWINGS

FIG. 1 is a block diagram of a voice activation system in accordance with an embodiment of the invention.

FIG. 2 is a block diagram of a voice activation system in accordance with another embodiment of the invention.

FIG. 3 is a flow diagram of a process for generating a bit array representing a voice signal in accordance with another embodiment of the invention.

FIG. 4 is a flow diagram of a process for determining whether two lines from bit arrays match.

FIG. 5 is a flow diagram of a process for determining how well two bit arrays representing voice commands match each other.

FIG. 6 is a flow diagram illustrating a process that divides a pair of arrays into multiple corresponding segments for comparisons.

FIG. 7 is flow diagram of a final recognition process for determining whether an input voice signal matches any of the voice commands stored in a command library.

Use of the same reference symbols in different figures indicates similar or identical items.

### DETAILED DESCRIPTION

In accordance with an aspect of the invention, a voice recognition and activation system employs voice signal processing hardware together with software or firmware executed on a microcontroller or microprocessor to perform training, voice recognition, and voice activation functions. The voice signal processing hardware includes a set of bandpass filters that separate an input voice signal into several channels having different energy carrier frequencies. The peak amplitudes in the bands during a time interval indicate the spectral energy or content of the voice signal during that interval, and each peak amplitude can be represented as a single bit in a voice key. Each bit in a voice key is “1” or “0” to indicate whether the corresponding peak amplitude was greater than a mean of the peak values for all the voice channels during the time interval. Collection of the voice keys for a series of time interval provides a bit array representing the voice signal, and these bit arrays can be stored in a library during training or compared to bit arrays in the library during voice recognition.

The voice signal processing hardware can be implemented on an integrated circuit chip having an analog section that initially processes a voice signal and produces a digital output characterizing the voice signal. Digital processing of the output can operate in a training mode for constructing and storing bit arrays in a library of voice commands and a recognition mode that compares a voice bit array constructed from an incoming voice signal to the bit arrays stored in the library of commands. When a command is recognized, a control signal identifying the voice command activates or controls the operation of an electronic device.

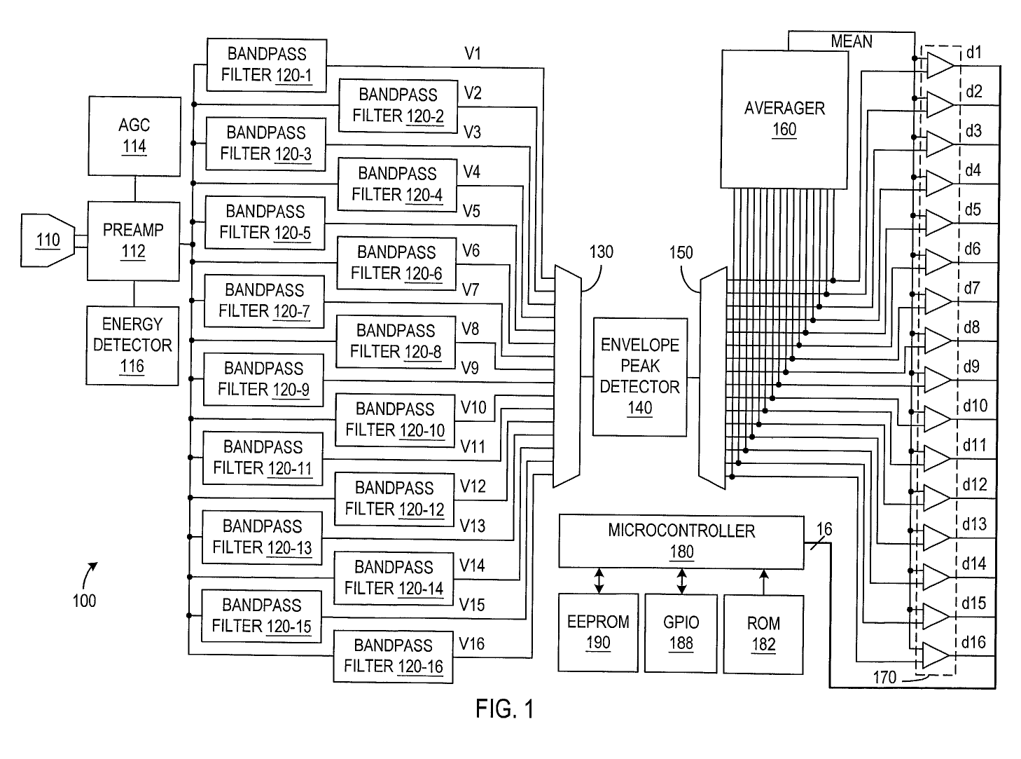

FIG. 1 illustrates a voice recognition and activation system 100 in accordance with an embodiment of the invention. System 100 includes a microphone 110, a preamplifier 112 with associated automatic gain control (AGC) circuit 114, an energy detector 116, bandpass filters 120-1 to 120-16, an envelope peak detector 140 with associated input multiplex 130 and output demultiplexer 150, an averaging circuit 160, differential amplifiers 170, and a microcontroller 180 with associated memories 182 and 190 and input/output interface 188.

System 100 can be implemented using one or more integrated circuits. For example, in one embodiment of the invention, all of the components of system 100, except microphone 110, are on a single integrated chip. In alternative embodiments, microcontroller 180 is a separate integrated circuit and can control the electronic device being activated or operated. Generally, memories 182 and 190 can be external or internal memories.

In operation, microphone 110 receives sound, which is presumed to contain spoken words, and generates a voice signal to preamplifier 112. Energy detector 116 measures the input sound energy and recognizes when the sound rises above or falls below a noise threshold level. Rising above or falling below noise threshold level can indicate the start or the end of a voice command. Preamplifier 112 amplifies the voice signal to a level that AGC 114 controls so that the resulting output signal has an amplitude within an optimal range for further signal processing.

Sixteen bandpass filters 120-1 to 120-16 receive the voice signal from preamplifier 112. Each of the sixteen bandpass filter 120-1 to 120-16 passes a signal in a different frequency band, so that the sixteen bandpass filters 120-1 to 120-16 separate the input voice signal into sixteen channels (signals V1 to V16) having different energy carrier frequencies fc.

In the exemplary embodiment, bandpass filters 120-1 to 120-16 are second order bandpass filters having frequency fc and Q values selected to avoid the energy overlap between adjacent bands and maximize the energy passed to channel signals V1 to V16. The center frequencies fc start at 300 Hz and increase by a factor of 1.20 for each succeeding channel up to a maximum carrier frequency of 4622 Hz. In the exemplary embodiment, Q is equal to 20 for each filter 120-1 to 120-16. Table 1 indicates the exemplary set of carrier frequencies for filters 120-1 to 120-16, but other frequency bands or a different number of filters would also be suitable.

TABLE 1
Center Frequencies (fc) of Bandpass Filters in Exemplary Embodiment

| Filter | Center Frequency (fc) | Filter | Center Frequency (fc) |
|---|---|---|---|
| 120-1 | 300 Hz | 120-9 | 1269 Hz |
| 120-2 | 360 Hz | 120-10 | 1574 Hz |
| 120-3 | 432 Hz | 120-11 | 1857 Hz |
| 120-4 | 518 Hz | 120-12 | 2229 Hz |
| 120-5 | 622 Hz | 120-13 | 2674 Hz |
| 120-6 | 746 Hz | 120-14 | 3209 Hz |
| 120-7 | 895 Hz | 120-15 | 3851 Hz |
| 120-8 | 1074 Hz | 120-16 | 4622 Hz |

Envelope peak detector 140 detects separate peak amplitudes for each of the channel signals V1 to V16 from bandpass filters 120-1 to 120-16, during a time interval Ts of about 20 ms. Multiplexer 130 and demultiplxer 150 can be used for time multiplexing during the time interval Ts to permit a single peak detector 140 to perform peak detection on all 16 channels. Envelope peak detector 140 samples the input channels via multiplexer 140 and outputs via demultiplexer 150 sixteen analog peak signals, which are constant-voltage analog signals. These analog signals effectively indicate the energies in respective channels during the time interval.

Averager 160 receives each channel's analog peak signals and generates an analog signal MEAN having a voltage level equal to the mean of the voltage levels of the analog peak signals. In one embodiment of the invention, averager 160 is an amplifier that sums 16 input analog peak signals and has a gain of 1/16.

Sixteen differential amplifiers 170 receive signal MEAN from averager 160 and respective peak signals from demultiplexer 150. Differential amplifiers 170 have respective CMOS level output signal d1 to d16, each of which is a bit indicating whether the voltage of the corresponding peak signal is greater than the mean voltage level. Output signals d1 to d16 collectively form a 16-bit voice key signal that microcontroller 180 receives for processing as described further below.

In the embodiment of FIG. 1, microcontroller 180 periodically samples the 16-bit voice key signal to construct what is referred to herein as a bit-map array. In the exemplary embodiment of the invention, the bit array contains a series of 16-bit lines that correspond to a voice command. Each line is a value of the voice key signal. The number of 16-bit lines depends on the duration of the voice command as indicated by time between energy detector 116 sensing the sound rising above the noise threshold level and falling back to the noise threshold level.

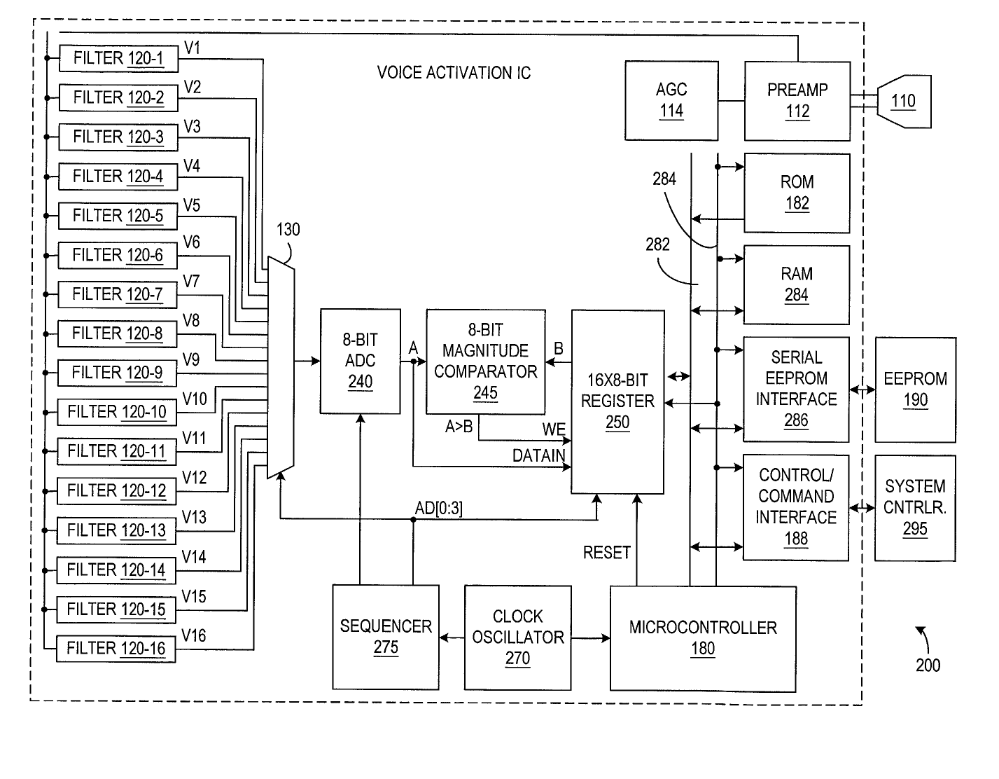

As an alternative to the embodiment of FIG. 1 more of the voice signal processing can be performed digitally. FIG. 2 shows a voice activation and recognition system 200 in accordance with another embodiment of the invention. System 200 of FIG. 2 differs from system 100 of FIG. 1 in that system 200 uses digital circuitry for envelope peak detection. System 200 includes microphone 110, preamplifier 112, AGC circuit 114, bandpass filters 120-1 to 120-16, and multiplexer 130, which operate as described above in reference to FIG. 1. System 200 also includes an analog-to-digital converter (ADC) 240, a comparator 245, a register 250, and a microcontroller 180 such as an Intel 8051.

A clock oscillator 270 generates the main clock signal and outputs the main clock signal to microcontroller 180 and to a clock sequencer 275. Clock sequencer 275 divides the main clock into slower clock signals. In particular, clock sequencer 275 generates a 4-bit address signal AD[0:3] for selecting the output signal of multiplexer 130 from among channel signals V1 to V16 and for selecting a stored value B from register 250. In system 200, register 250 stores sixteen data values corresponding to the sixteen bandpass filters 120-1 to 120-16, and address signal AD[0:3] cycles to sequentially select bandpass filters 120-1 to 120-16 and the associated values stored in register 250. Clock sequencer 275 also controls the timing of operations by ADC 240, comparator 245, and register 250 so that those circuits operate in order.

In response to address signal AD[0:3], multiplexer 130 selects an analog channel signal from one of filters 120-1 to 120-16, and ADC 240 provides to comparator 245 a digital signal A indicating the magnitude of the selected channel signal. Simultaneously, register 250 provides to comparator 245 a stored digital value B corresponding to address signal AD[0:3] and the selected bandpass filter. Comparator 245 compares digital values A and B and activates a write enable signal of register 250 if value A is greater than value B. When the write enable signal is active, register 250 replaces the value B with the larger value A. Accordingly, the values in register 250 indicate the greatest or peak magnitudes that the analog channel signals have had since register 250 was last reset.

Microcontroller 180 executes firmware that periodically reads and averages the peak values for each channel from register 250, determines mean of the peak values of the different channels, and for each peak value determines whether or not the peak value is greater than the mean. Microcontroller 180 then constructs a 16-bit voice key value where the sixteen bits of the voice key correspond to the sixteen averaged values from register 250 and are “1” or “0” depending on whether the corresponding averaged values are greater than the mean.

After reading the contents of register 250 for construction of a voice key value, microcontroller 180 resets the values in register 250 to zero. The values in register 250 then increase according to the magnitudes of corresponding channel signals V1 to V16 from bandpass filters 120-1 to 120-16 until microcontroller 180 again reads register 250. In the exemplary embodiment of the invention, microcontroller 180 reads register 250 every Ts seconds (e.g., about once every 20 ms) and determines a voice key value about every Ts seconds, so that each voice key corresponds to a Ts second portion of the voice signal. During that time, ADC 240 samples each of the analog signals from bandpass filters 120-1 to 120-16 at a frequency of about 8 kHz. Accordingly, ADC 240 samples each voice band about Ts(second)×8000/(second) times for each voice key value in the exemplary embodiment of the invention.

Microcontroller 180 constructs a bit array corresponding to a voice command from the voice key values. In a bit array, each voice key value has a time index that determines its position (sometimes referred to herein as its vertical position) in the bit array. Microcontroller 180 identifies the start and end of a voice command and therefore the start and end of the bit array (i.e., the number of key values or lines in the bit array) from observing values in register 250 having magnitudes below a noise threshold.

FIG. 2 also illustrates a typical interface for microcontroller 180. In particular, microcontroller 180 has a data bus 282 and an address bus 284 that are connected to register 250, internal ROM 182, an internal RAM 284, a memory interface 286, and control/command interface 188. ROM 182 can store firmware for microcontroller 180 and bit arrays for factory defined voice commands. RAM 284 is volatile memory such as DRAM or SRAM that microcontroller 180 uses for software execution. Memory interface 286 is an interface to internal or external memory such as a serial EEPROM or a flash memory that store software or voice command bit arrays. By using non-volatile memory such as EEPROM or flash memory, software or voice commands bit arrays still can be retained after a power shutdown. Control/command interface 188 provides an interface to a system controller of the electronic device being activated or operated through voice commands.

The voice recognition and activation systems described above have two operating modes, a training mode and a recognition mode: In the training mode, a user speaks a voice command into microphone 110, and microcontroller 180 constructs a bit array from the resulting series of voice key values and stores the bit array in non-volatile memory 190, which in the exemplary embodiment of the invention is an external EEPROM or flash memory device. The size and number of the training words are only limited by the size of memory 190.

When storing a voice command during training, microcontroller 180 assigns to the voice command (or a series of stored voice commands) to a function of the device being controlled. In the embodiments of FIGS. 1 and 2, microcontroller 180 has interface 188 for connection to the device being controlled, and microcontroller 180 activates a particular signal or signals through interface 188 to activate a corresponding function of the device being controlled. Accordingly, the assignment of a function to a particular voice command during training can simply assign an address or pin of the interface to the voice command. Alternatively, a stored voice command or an ordered sequence of stored voice commands can be assigned to a procedure that activates a more complicated sequence or combination of signals.

Each device function typically has only one voice command, but more than one voice commands stored during training mode can be assigned to the same function. Multiple voice commands for the same function allows multiple users to train system 100 to recognize their distinct voices or commands. Assigning multiple stored voice commands to the same function also allows alternative words to activate the same function. Even if only one user always uses the same word for activation of a particular function, assigning multiple stored voice commands to the same function may facilitate recognizing commands, which are subject to variations in speech patterns.

In addition to or instead of storing bit-map arrays in EEPROM 190 during training, EEPROM 190 or memory 182 can contain or factory installed bit arrays that are assigned to selected functions.

In the recognition mode, microphone 110 receives the voice signal (words), and microcontroller 180 extracts the voice key values for construction of a voice bit array representing a voice command. Microcontroller 180 then executes a bit array matching procedure to match horizontal lines in this voice bit-map array to horizontal lines in the stored bit-map arrays in EEPROM 190. After that, microcontroller 180 can executes a vertical verification process to make sure the matching stored bit array also fits into the vertical pattern of the voice bit array. By this step, the system can reject matches that are reasonable based on comparisons of selected horizontal lines but vertically contain extra or deleted content. If a good horizontal and vertical match is found, microcontroller 180 identifies the function assigned to the best match bit array in EEPROM 190 and uses interface 188 to activate the assigned function.

The software that microcontroller 180 executes during the recognition process can be stored in ROM 182. The software includes portions for bit array generation and bit array matching. The bit array matching can include procedures for bit array comparisons using a dynamic method of line matching that alternates between the top and bottom of bit arrays or a segments of bit arrays, bit array vertical matching verification, and final matching with a gap control method to distinguish voice commands corresponding to different functions.

Bit array generation, which is used in both training and recognition modes, uses the voice key values derived from voice band signals V1 to V16. Each voice band signal Vn has a voltage amplitude indicated in Equation 1, where n is a channel index ranging from 1 to 16, t is time, fc(n) is the narrow band center frequency of channel n (e.g., fc(1)=300 Hz, fc(2)=3600 Hz, . . . fc(16)=4622 Hz), An(t) is the envelope for channel n (i.e., the energy carried by center frequency fc(n)), and Φ(n) is the phase delay for channel n.

V(n)=An(t)Sin {2πfc(n)+Φ(n)} Equation 1

In system 200 of FIG. 2, register 250 collects peak values Apn of signals Vn for channel index n from 1 to 16. Each peak value Apn indicates an amount of energy in the channel and is effectively the maximum of that envelope An(t) reaches within a time interval since register 250 was reset.

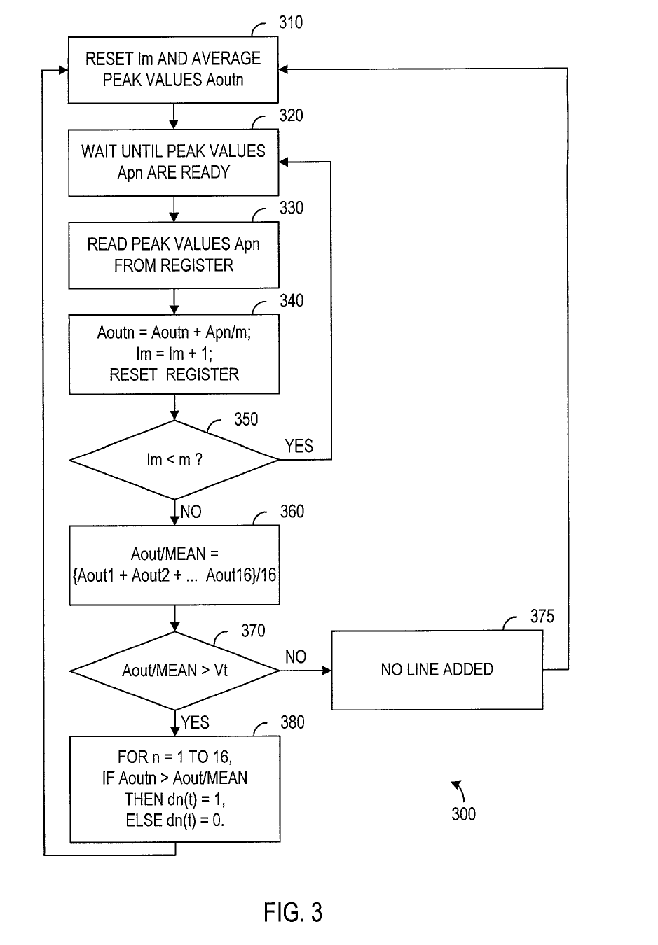

FIG. 3 is a flow diagram of a process 300 that uses the system of FIG. 2 to generate a bit array representing a voice command. Process 300 begins in step 310 with processor 180 resetting an index Im and peak average peak values Aoutn to zero. Processor 180 then waits in step 320 until peak values Apn are ready, and then in step 330, processor 180 reads peak values Apn. In the exemplary embodiment, microcontroller 180 reads peak values Apn for channel index n between 1 and 16 from register 250m (e.g., m=16) times in every Ts seconds (e.g., Ts=20 ms).

Each time microcontroller 180 reads peak values from register 250, microcontroller 180 increments index In and adds contributions of the current peak values Apn into accumulated averages Aoutn. After reading the peak values Apn for m times (e.g., m=16), microcontroller 180 finishes determining the average peak values Aoutn for each channel as indicated in Equations 2. These average peak values Aoutn represent a portion of the voice signal that lasts a time Ts (e.g., 20 ms) and has a time index t.

Aout1(t)={Ap1(t+Ts/m)+Ap1(t+2Ts/m)+ . . . +Ap1(t+mTs/m)}/m Equations 2

Aout2(t)={Ap2(t+Ts/m)+Ap2(t+2Ts/m)+ . . . +Ap2(t+mTs)/m}/m

Aout16(t)={Ap16(t+Ts/m)+Ap16(t+2Ts/m)+ . . . +Ap16(t+mTs/m)}/m

After determining average peak values Aoutn, microcontroller 180 then determines a mean Aout/mean of the sixteen average peak values Aout1 to Aout16 as indicated in Equation 3 and shown as step 360 in FIG. 3. If in step 370 mean Aout/mean is above a threshold that depends on the noise level, microcontroller 180 adds a line to the current bit array. Otherwise the voice signal is interpreted as having no voice information in this time frame, and no line is added to current bit array.

Aout/mean(t)={Aout1(t)+Aout2(t)+ . . . +Aout16(t)}/16 Equation 3

In the exemplary embodiment of the invention, a line of the bit array contains sixteen bits d1 to d16, one for each channel n, and a bit dn corresponding to a channel n has a value “1” if the corresponding average peak Aoutn is greater than mean Aout/mean. Otherwise, the bit corresponding to channel n is “0”. If Aout/mean(t) is less than or equal to a noise threshold Vt, the sound energy is low indicating of no voice information for the voice command, and microcontroller 180 does not insert an accumulated bit array line for this time interval. In either case, microcontroller 180 returns to step 310 and starts to check the next Ts time frame for the next bit array line.

The final bit array has the form illustrated in Table 2. As shown in Table 2, each line contains 16 bit, but the number of lines x depends on the spoken length of the voice command.

TABLE 2
Bit array form

| | | | | | | |
|---|---|---|---|---|---|---|
| d(1,1) | d(1,2) | . . . | d(1,i) | . . . | d(1,16) | 1st line D1 with 16 bits |
| d(2,1) | d(2,2) | . . . | d(2,i) | . . . | d(2,16) | 2nd line D2 with 16 bits |
| . . . | . . . | . . . | . . . | . . . | . . . | |
| d(x,1) | d(x,2) | . . . | d(x,i) | . . . | d(x,16) | xth line Dx with 16 bits |

During the training mode, all the training voice commands are converted into bit arrays and then stored into non-volatile memory. During the recognition mode, the voice commands that need to be recognized are converted into bit arrays and then compared to the stored bit arrays using a recognition process such as described further below.

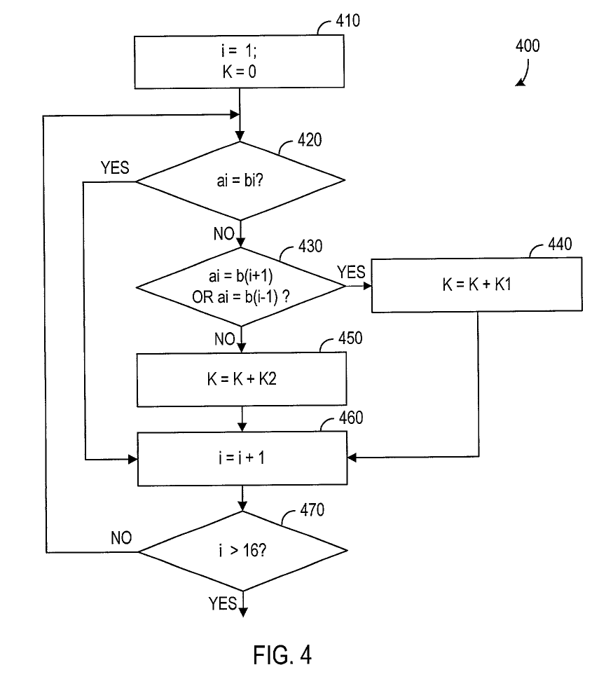

The exemplary embodiment of the invention, which compares lines of bit arrays, uses a bit position weighted K factor in comparing two lines. FIG. 4 is a flow diagram of a process 400 for comparing two lines A and B, which respectively include bits a1 to a16 and b1 to b16. Process 400 begins in step 410 by initializing a bit index i and a factor K for the comparison. Bit ai is compared to bit bi in step 420. If bits ai and bi are the same (both “0” or both “1”), process 400 branches from steps 420 to step 460 without changing factor K.

If bits ai and bi are not the same, process 400 branches from step 420 to step 430 and compares bit ai to bits b(i−1) and/or b(i+1), which are in neighboring positions in line B. If bit ai is equal to bit b(i−1) or b(i+1), factor K is increased by a first K-factor K1 (e.g., K1=1) in step 440. If bit ai is equal to neither bit b(i−1) nor b(i+1), step 450 increases factor K by a second K-factor K2 (e.g., K2=2).

Steps 460 and 470, which follow step 420, 440, or 460, increment bit index i and determine whether all bits in line A have been compared to bits in line B. After all bits in line A have been compared, process 400 is over, and factor K indicates how closely line A matches line B. The two lines match perfectly if factor K is zero. A higher value of factor K indicates a poorer match between lines A and B.

Speech rates can vary the duration of voice commands, so that generally two bit arrays being compared will not contain the same number of lines even if the two bit arrays represent the same voice command. To identify matching bit arrays even when the bit arrays do not contain the same number of lines, the exemplary embodiment of the invention uses a bit-map matching comparison having a top-bottom dynamic approach. Generally, comparing a bit array A having lines A1 to An {bits a(1,1), . . . a(1,16) to a(n,1), . . . a(n,16)} to a bit array B having lines B1 to Bm {bits b(1,1), . . . b(1,16) to b(m,1), . . . b(m,16)} requires identifying which line of one bit array corresponds to a particular line in the other array. Both bit arrays have 16 bits per line, but the number of lines m in bit array B could be equal to or not equal to the number n of lines in bit array A.

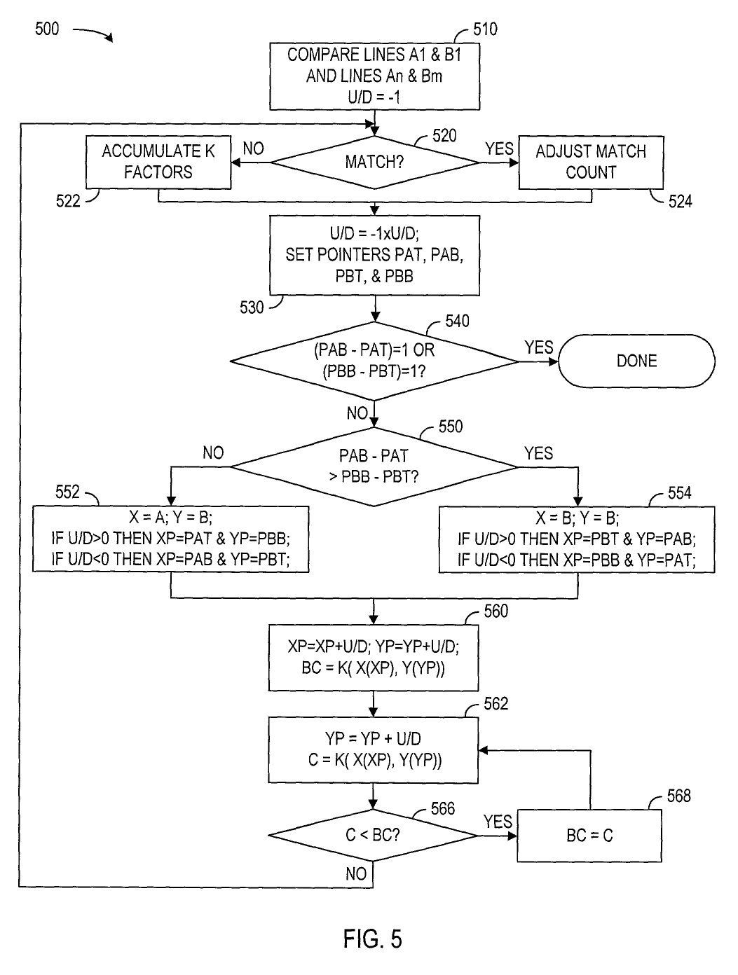

FIG. 5 is a flow diagram of an array comparison process 500 in accordance with an embodiment of the invention. Process 500 starts in step 510 by comparing the top lines A1 and B1 of the two bit arrays A and B using the position weighted K-factor determination process 400 of FIG. 4. Step 510 also compares the bottom lines An and Bm of bit arrays A and B using the position-weighted K-factor determination. For each of these comparisons, steps 520, 522, and 524 determine whether the pair of lines matched and then increments a count of the number of matching lines or accumulate the K factors of non-matching lines.

Step 530 sets the values of top and bottom pointers PAT and PAB in bit array A, top and bottom pointers PBT and PBB in bit array B, and a flag U/D that indicates a search direction for subsequent comparisons. Initially, top pointers PAT and PBT point to the top lines A1 and B1 in arrays A and B, respectively, and bottom pointers PAB and PBB point to the bottom lines An and Bm in arrays A and B, respectively. Flag U/D initially indicates a top-down comparison process in the exemplary embodiment.

Step 540 determines whether the top and bottom pointers of either array A or B point to adjacent lines. If top and bottom pointers point to adjacent lines, the array comparison process is complete. Otherwise, process 500 proceeds from step 540 to step 550.

Steps 550, 552 and 554 select as a source array X whichever array A or B has the fewest lines between corresponding pointers PAT and PAB or PBT and PBB. A pointer XP for the source array is either the top pointer PAT or PBT or the bottom pointer PAB or PBB depending on the search direction (top-down or bottom-up) that flag U/D indicates. The other array becomes the target array Y, and a pointer YP for the target array is the same as top pointer PBT or PAT or bottom pointer PBB or PAB again depending on the search direction that flag U/D indicates.

In step 560, pointers XP and YP are shifted according to the search direction, and the line then corresponding to pointer XP in the source array X is compared to a series of lines in the target array Y beginning with the line corresponding to pointer YP. For each comparison in the series, the target pointer YP changed by U/D (i.e., incremented for a top-down series or decremented for a bottom-up series). The series of line comparisons stops when a comparison K result is greater than the match results for the previous comparison. In FIG. 5, step 560 performs a comparison of lines that pointers XP and YP select and sets an initial value of a best comparison BC to the determined K factor. Step 562 shifts pointer YP (down or up) to the next line in the target array and compares the line from the source array to the next line in the target array. If in step 566, the comparison from step 562 provides factor C that is less than the best factor BC, step 568 sets the best factor BC equal to the newly determined factor C, and process 500 returns to step 562. Step 562 is thus repeated until the newly determined factor C is greater than the previous determined best factor BC. Process 500 then branches back to step 520 and determines whether the best factor BC indicates matching lines. Steps 522 and 524 update the match count and accumulated K factor accordingly.

Step 530 then sets top pointers PAT and PBT or bottom pointers PAB and PBB, depending on flag U/D, according to the best-match lines found in steps 560, 562, 566, and 568. Step 530 also switches flag U/D so that the next set of comparisons proceeds in the opposite direction (e.g., switches from top-down to bottom-up or from bottom-up to top-down).

Process 500 continues to reselect source array X and alternate between top-down and bottom-up searches for best match lines until step 540 determines there are no more lines to compare in one of the bit arrays. As a result of this process, the match count and the accumulated K factor indicate how well the two bit arrays match each other.

Equation 4 is a formula for a match percentage indicating how well the two arrays match. In Equation 4, MatchCount is the count of matching lines. Generally, a high match percentage indicates matching arrays, but further comparisons of the arrays as described below can be performed to confirm that two arrays match each other.

Total matching %=(MatchCount×16−total unmatched K factors)/(MatchCount×16) Equation 4

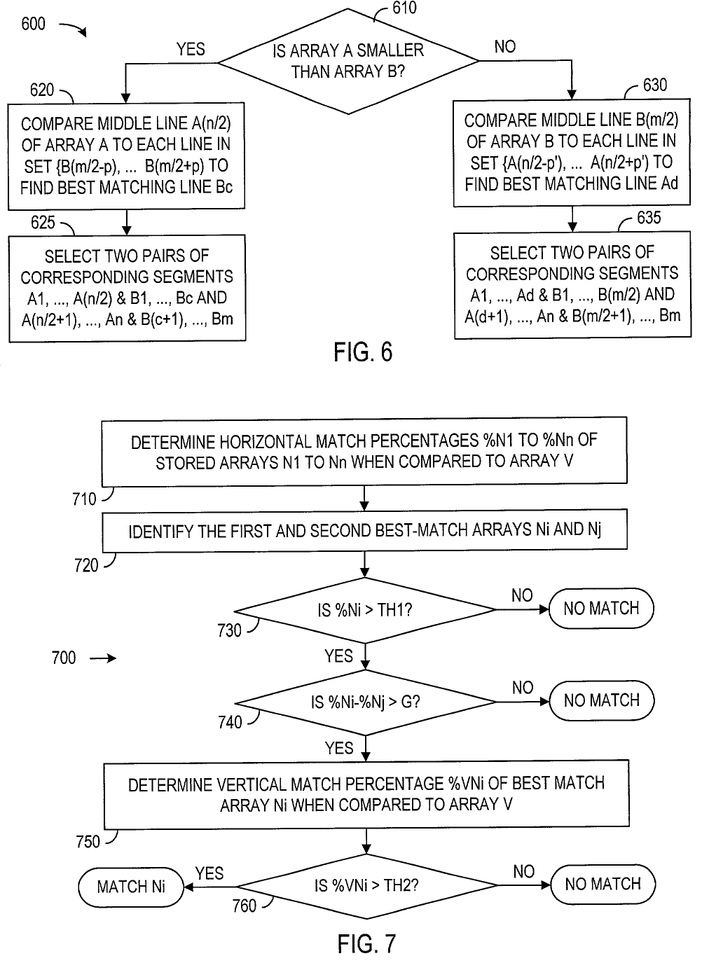

In accordance with another aspect of the invention, bit arrays can be divided into separate segments during voice recognition mode. FIG. 6 illustrates a process 600 for breaking a bit array into multiple segments. Process 600 improves the recognition result regardless of number of the voice words.

Assume two bit arrays A and B need to be matched, (e.g., bit array A is from a voice signal that needs to be recognized and bit array B is a stored bit array form the EEPROM.) In the embodiments described above, each bit array has sixteen bits per line. Array A has n lines, and array B has m lines.

If m and n are even number, line A(m/2) is a middle line of array A, and line B(n/2) is a middle line of array B. If m and n are odd numbers, line A((m+1)/2) is the middle array line of array A, and line B((n+1)/2) is the middle line of array B. To simplify illustration of segmentation process 600, the following assumes that m and n are even.

Process 600 begins segmenting of arrays A and B by partitioning each array into two segments. In step 610, the array having the fewest lines (bit array A or B) is selected as a source array, and the other array (bit array B or A) is the target array. A middle line of the source array is then compared to a series of lines centered on a middle line of the target array. For example, if bit array A is smallest, step 620 compares middle line A(n/2) to lines B(m/2−p), B(m/2−(p−1)), . . . , B(m/2−2), B(m/2−1), B(m/2), B(m/2+1), B(m/2+2), . . . , B(m/2+(p−1)) and B(m/2+p), where value p, which controls number of comparisons, is about 25% of m. If bit array B is smallest, step 630 compares middle line B(m/2) to lines A(n/2−p′), to A(n/2+p′), where value p′ is about 25% of n.

Process 600 uses the bit position weighted K factor method of FIG. 4 identify the target line that best matches source middle line. The best match line in the target array and the middle line in the source array at the boundary of two segments in the respective bit arrays as indicated steps 625 and 635 of FIG. 6.

Each of pair of matched segments A′ and B′ and A″ and B″ can be further broken into segments using the same process 600 that broke arrays A and array B into segments. As a result of applying process 600 to the paired segments of arrays A and B, each array A or B is broken into four segments as illustrated in Table 3.

TABLE 3
Segmented Arrays

| | Array A | Array B |
|---|---|---|
| Segment 1 | Lines A1 to Aq | Lines B1 to Br |
| Segment 2 | Lines A (q + 1) to As | Lines B (r + 1) to Bt |
| Segment 3 | Lines A (s + 1) to Au | Lines B (t + 1) to Bv |
| Segment 4 | Lines A (u + 1) to An | Lines B (v + 1) to Bm |

After the bit arrays are broken into segments (e.g., four segments per array in this example), each pair of segments is compared using the process of FIG. 5 to determine the number of matched lines and the total K factor for unmatched lines. A total match percentage MATCH % for the bit arrays can be determined using Equation 5, wherein L1, L2, L3, and L4 are the number of matched lines in respective segments 1, 2, 3, and 4 of Table 3 and U1, U2, U3, and U4 are the total K factors for the unmatched lines in respective segments 1, 2, 3, and 4.

MATCH %={(L1+L2+L3+L4)·16−(U1+U2+U3+U4)}/(L1+L2+L3+L4)·16 Equation 5

The recognition methods described above relies on line matching, which effectively matches the horizontal ordering of bits in selected pairs of lines. In accordance with an aspect of the invention, recognition of matching bit arrays can be further verified using a vertical comparison process. In particular, after the bit arrays are broken into multiple segments and line matching indicates two bit arrays match, the match is further verified with vertical checking.

One a process for vertical checking of arrays performs a vertical OR operation on each segment and compares the OR results of corresponding segments. Table 4 illustrates a vertical OR operation performed on sample data for two corresponding segments of arrays A and B.

TABLE 4
Vertical Verification

| | A (segment1) | B (segment1) |
|---|---|---|
| Line 1 | 0 0 1 1 0 0 1 0 0 0 0 0 0 1 1 1 | 0 0 0 0 0 1 0 0 0 0 0 0 1 1 1 1 |
| | 0 0 0 0 0 0 1 0 0 0 0 0 1 1 1 1 | 0 0 0 0 0 1 0 0 0 0 0 0 1 1 1 0 |
| . . . | 0 0 0 0 0 1 1 0 0 0 0 0 1 1 1 1 | 0 0 0 0 0 1 1 0 0 0 0 0 1 1 1 0 |
| | 0 0 0 0 0 1 1 0 0 0 0 0 1 1 1 0 | 0 0 0 0 0 0 1 0 0 0 0 0 1 1 1 0 |
| Line r | 0 0 0 0 0 0 0 1 0 0 0 1 1 1 1 0 | 0 0 0 0 0 0 0 1 0 0 0 0 1 1 1 0 |
| . . . | 0 0 0 0 0 0 0 0 0 0 0 1 1 1 1 0 | |
| Line q | 0 0 0 0 0 0 0 0 1 0 0 1 1 1 1 0 | |
| Vertical | 0 0 1 1 0 1 1 1 1 0 0 1 1 1 1 1 | 0 0 0 0 0 1 1 1 0 0 0 0 1 1 1 1 |
| OR Result | | |
| Line | | |

The weighted K factor method of FIG. 4 can be used to compare the OR result lines of corresponding segments of bit arrays A and B. In the exemplary embodiment where arrays A and B are divided into four segments the comparisons yield four K factors VK1, VK2, VK3, and VK4 corresponding to the four pairs of segments.

A vertical match percentage VMATCH % can be determined using Equation 6

VMATCH %={16×No. of segs.−sum of unmatched K factors in all segs.}/{16×No. of segs.}={64−(VK1+VK2+VK3+VK4)}/64 Equation 6

if there are 4 segments

A final matching result can use a gap control method to avoid identifying a match when the horizontal and/or vertical match percentages indicate a voice command matches two or more stored bit arrays that correspond to different functions. Assume there are n trained bit arrays (N1, N2, . . . Nn) stored in the EEPROM. If a voice signal V needs to be recognized, microcontroller 180 compares voice signal V to each stored array N1, N2, . . . Nn and gets a final recognition result according to a process 700 illustrated in FIG. 7.

Process 700 begins in step 710, which gets horizontal match percentage results % Nl to % Nn from comparing voice bit array V to each of the stored bit arrays N1 to Nn. Based on the horizontal match percentages % Nl to % Nn, step 720 identifies a best-match stored array Ni having the highest horizontal match percentage % Ni and a second best match stored array Nj having the highest best match percentage % Nj associated with a function or meaning that differs from the function or meaning of stored array Ni.

Step 730 then determines whether best match percentage Ni is greater than a threshold TH1, for example, greater than 75%. If match percentage % Ni is less than the threshold TH1, no match was found, and process 700 ends. If the match percentage % Ni is greater than the threshold percentage, process 700 performs a gap determination in step 740.

In step 740, process 700 determines whether the difference between match percentages % Ni and % Nj is greater than a required gap G, for example, greater than 5%. If not, process 700 determines no match was found. If the difference between the match percentages % Ni and % Nj is greater than the minimum gap, process 700 continues to step 750.

Step 750 determines the vertical match percentage % VNi from a comparison of voice bit array V and best-match array Ni. Step 760 then determines whether vertical match percentage % VNi is greater than a minimum threshold TH2, for example, greater than 75%. If vertical match percentage % VNi is not greater than the required threshold TH2, process 700 determines that no match was found. If vertical match percentage % VNi is greater than the required threshold TH2, bit array Ni is confirmed as the final match bit array V, and processor 180 directs a device to take an action corresponding to stored array Ni.

In accordance with yet another aspect of the invention, the voice recognition sensitivity can be adjusted through setting the different levels for thresholds TH1, TH2, and G. Generally, increasing thresholds TH1, TH2 and G decreases the sensitivity for recognition, e.g., decreases the likelihood that a voice signal will match a stored voice command. In an embodiment of the invention such as illustrated in FIG. 1 or 2, the GPIO interface can permit setting of the different levels for threshold TH1, TH2 and G for different applications.

Although the invention has been described with reference to particular embodiments, the description is only an example of the invention's application and should not be taken as a limitation. For example, although the above embodiments employ sixteen frequency channels for voice analysis, any number of such channels could be used. Additionally, although specific hardware is described above, that hardware is merely an example of a suitable system. The procedures described herein can be performed using such hardware or can be implemented entirely in software executed on a general-purpose processor. Various other adaptations and combinations of features of the embodiments disclosed are within the scope of the invention as defined by the following claims.

We claim:

1. A voice circuit comprising:
a plurality of filters connected in parallel to receive a voice signal; and
an energy detection circuit connected to outputs of the filters, the energy detection circuit determining amounts of energy in respective output signals from the filters.

2. The circuit of claim 1, further comprising a processing circuit connected to the energy detection circuit, wherein the processing circuit generates a bit array representing time evolution of the energy in the output signals of the filters.

3. The circuit of claim 2, wherein the bit array comprises a plurality of lines, wherein each line corresponds to a time interval of the voice signal and contains a plurality of bits in correspondence with the plurality of filters, each bit having a value indicating whether the output signal of the corresponding filter was above a threshold during the time interval corresponding to the line containing the bit.

4. The circuit of claim 3, wherein the threshold is an average of the energies of the output signals of the filters during the time interval corresponding to the line.

5. A voice recognition process comprising:
constructing a voice bit array representing a portion of a voice signal, wherein the voice bit array includes a plurality of lines, each line includes a plurality of bits, and each bit in a line has a value indicating whether in the voice signal, a frequency band corresponding to the bit had an energy greater than a threshold level during a time interval corresponding to the line; and
comparing the voice bit array to a stored bit arrays to determine whether the voice bit array matches the stored bit array.

6. The process of claim 5, wherein comparing the voice bit array to a first of the stored arrays comprises:
(a) selecting one of the voice bit array and the stored bit array as a source array and selecting the other of the voice bit array and the stored bit array as a target array;
(b) comparing a middle line of the source array to each line in a range of lines containing a middle line of the target array;
(c) identifying in the range, a best match line that is the line best matching the middle line of the source array;
(d) splitting the source array into a first segment including lines from a beginning of the source array to the middle line of the source array and a second segment including lines from the middle line of the source array to an end of the source array; and
(e) splitting the target array into a first segment including lines from a beginning of the target array to the best-match line of the target array and a second segment including lines from the best-match line of the target array to an end of the target array.

7. The process of claim 6, further comprising:
selecting one of the first segment of the source array and the first segment of the target array as the source array and selecting the other of the first segment of the source array and the first segment of the target array as the target array; and then
repeating steps (b) through (e) of claim 6.

8. The process of claim 7, further comprising:
selecting one of the second segment of the source array and the second segment of the target array as the source array and selecting the other of the second segment of the source array and the second segment of the target array as the target array; and then
repeating steps (b) through (e) of claim 6, whereby each of the voice bit array and the stored array are divided into four segments.

9. The process of claim 8, further comprising separately comparing each segment of the voice bit array to a corresponding segment of the first stored array.

10. The process of claim 6, wherein selecting one of the voice bit array and the stored bit array as the source array comprises selecting whichever of the voice bit array and the stored bit array is shorter.

11. The process of claim 5, wherein comparing the voice bit array to the stored bit array comprises:
(a) identifying a portion of the voice bit array and a portion of the stored bit array to be compared to each other;
(b) selecting one of the portion of the voice bit array and the portion of the stored bit array as a source array and selecting the other of the portion of the voice bit array and the portion of the stored bit array as a target array;
(c) comparing an end line in of the source array to a series of lines in the target array to identify a best matching line in the series, wherein the series begins at an end line in the target array and proceeds in a selected direction;
(d) reversing the selected direction; and then
(e) repeating step (a) through (c).

12. The process of claim 11, wherein repeating step (a) comprises removing the end line of the source array and the series of lines up to the best match line from the portions of the voice bit array and the stored bit array.

13. The process of claim 12, further comprising repeating steps (a) through (e) until step (a) identifies the portion of the voice bit array or the portion of the stored bit array does not contain any lines for comparisons.

14. The process of claim 5, wherein comparing the voice bit array to the stored bit array comprises:
partitioning each of the voice bit array and the stored bit array into a plurality of segments, wherein each segment contains a plurality of lines and each segment of the voice bit array has a corresponding segment in the stored bit array;
for each segment, performing an OR operation on the lines of the segment to generate a result line for the segment; and
comparing the result lines for corresponding segments.

15. The process of claim 5, wherein comparing the voice bit array to the stored bit array comprising comparing a first line and a second line, wherein the first line is in the voice bit array and the second line is in the stored bit array.

16. The process of claim 15, wherein comparing the first and second lines comprises determining a factor by combining contributions associated with the bits of the first line, wherein each bit in the first line has a contribution that is:
zero if the bit is equal to an identically-positioned bit in the second line;
a first value if the bit is not equal to the identically-positioned bit in the second line and is equal to either bit adjacent to the identically-positioned bit in the second line; and
a second value if the bit is not equal to an identically-positioned bit in the second line and equal to neither bit adjacent to the identically-positioned bit in the second line.

17. The process of claim 16, wherein the second value is greater than the first value.

18. The process of claim 5, further comprising comparing the voice bit array to a plurality of stored bit arrays which if any of the stored bit array matches the voice bit array.

19. The process of claim 18, wherein comparing the voice bit array to the plurality of stored bit arrays comprises:
comparing lines in the voice bit array to lines in each of the plurality of stored bit arrays to generate for each stored bit array a match value indicating how well the voice bit array matches the stored bit array;
identifying a first stored bit array having a first match value indicating out of the plurality of stored arrays, the first stored bit array matches the voice bit array best;
generating a result indicating no match was found and ending the process if the first match value is less than a first threshold;
identifying a second stored bit array having a second match value indicating out of the plurality of stored arrays, the second stored bit array matches the voice bit array second best;
generating the result indicating no match was found and ending the process if a difference between the first match value and the second match value is less than a required gap;
partitioning each of the voice bit array and the first stored bit array into a plurality of segments, wherein each segment contains a plurality of lines and each segment of the voice bit array has a corresponding segment in the first stored bit array;
for each segment, performing an OR operation on the lines of the segment to generate a result line for the segment;
comparing the result lines for corresponding segments to generate a third match value indicating how well the voice bit array matches the stored bit array; and
generating the result indicating no match was found if the third value is less than a second threshold, otherwise a second result indicating a match was found.

20. The process of claim 19, further comprising selecting the first threshold, the second threshold, and the gap according to a desired voice recognition sensitivity.
